(19) United States
(12) Patent Application Publication
(10) Pub. No.: US 2002/0169580 A1
(43) Pub. Date: Nov. 14, 2002

(54) Aging measuring device

(76) Inventor: Kalman N. Lehoczky, Palmetto, FL (US)

Correspondence Address: KALMAN LEHOCZKY, 4411 16TH AVE. E., PALMETTO, FL, 34221, US

(21) Appl. No.: 09/851,002

(22) Filed: May 9, 2001

(51) Int. Cl. G06F 17/18; G06F 15/00

(52) U.S. Cl. 702/181

(57) ABSTRACT

Aging measuring device, receiving electrical information about the operational conditions in electromagnetic apparatus, computes the aging of vital components in the electromagnetic apparatus and presents the aging velocity, the used up and remaining life, risk level and the fictive aging velocity and risk level for “what if” operational scenarios.

### BACKGROUND OF THE INVENTION

1. Field of Invention

Electromagnetic apparatus are stationary equipments such as transformers, reactors, electro-magnets, measuring and controlling equipment and rotating equipment such as alternators, generators, dynamos, motors, converters, etc., based on the interaction of electric currents and magnetic fields.

2. Description of the Prior Art

Many of the electromagnetic apparatus are part of mechanical, thermal, hydraulic energy conversion systems. Typically, the electromagnetic apparatus has a “nominal” or “rated” electrical or mechanical output. Similarly, there are “rated” values for other operating parameters such as voltage, speed, etc. The operator, using the typical and conventional instrumentation showing the current operational parameters as reference, adjust controls of the electromagnetic apparatus to come as close as possible to needed level of output parameters but not exceeding “rated” values. During certain seasonal periods or in connection with advantageous power market situation, it would be desirable to exceed the “rated” levels. The operator knows that operation beyond the “rated” may increase the risk for faults and would surely reduce the life-expectancy of the apparatus and connected equipment. Since no risk and aging data is available for the equipment, the operator must chose the safe choice, up to the “rated” values, missing the eventual gain with respect to the total economy.

The objective of the present invention is to provide an aging measuring device for electromagnetic apparatus which can calculate the ongoing aging speed, the cumulative used and remaining life and the risk level A further objective is to provide means to calculate the fictive aging speed for “what if” operational conditions.

### SUMMARY OF THE INVENTION

Briefly stated, in accordance with one aspect of the present invention, the foregoing objectives are achieved by introducing an age measuring device comprising of instruments measuring the current electric, magnetic, thermal, mechanical, radiation, climatic and chemical conditions in the electromagnetic apparatus and via signal cables, signal conditioning and conversion components connected to the primary input port of a central unit transferring the converted electrical signals to the processor and a secondary input port transferring operation commands, constants and fictive operational conditions from manually operated input device to the processor which operation is controlled by programs specific for the electromagnetic apparatus and stored temporarily in the Random Access Memory and accessible for the connected large capacity memory drive and an output port connected to the processor communicating the calculated aging speed, used up life, remaining life and risk level to the connected readout device showing the calculated aging speed, used up life, remaining life and risk levels.

Other features of the invention will be described in connection with the drawing.

### DESCRIPTION OF THE DRAWING

FIG. 1 shows an electromagnetic apparatus 1, for example a hydro-generator (alternator) and a non-electromagnetic apparatus, for example turbine in the same system.

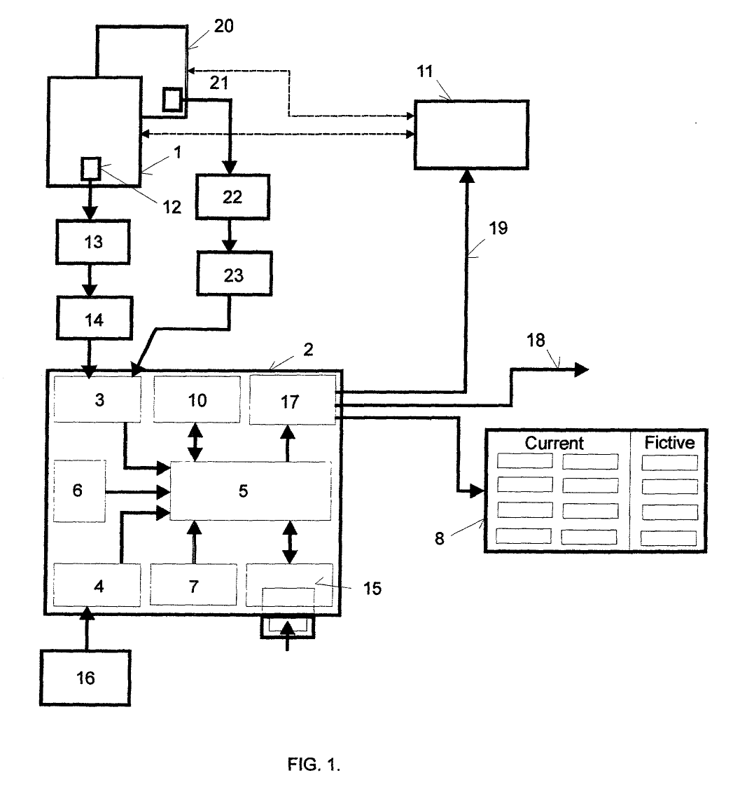

The operation of the electromagnetic apparatus 1 and the non-electromagnetic apparatus 20 is controlled by manual and/or automatic local or remote controller 11 and via control lines 9. There are measuring instruments and probes 12 are installed and in connection with the electromagnetic apparatus 1 measuring typically the following conditions: power, MW; reactive power, MVAr; stator voltage, kV; stator current, kA; rotor current, Ie; stator temperatures, Ta; rotor temperatures, Te; cooling system temperatures, Tc; partial discharge levels, PD; rotational speed, rpm; and shaft displacement and structural vibration values as amplitudes, velocities or accelerations; etc. It is assumed that the measuring instruments and probes are producing electrical signals correctly representing the measured values. The electrical signals may be amplified and/or modified in signal conditioners and converters 13 to be transported in electrical, optical or wireless way to converters, filters, amplifiers, and analogue-digital converters 14 to the primary input port 3 of the central unit 2. The invention's validity is not limited by the type and number of the instruments, measuring transformers, sensors and probes, signal conditioners, filters, amplifiers, optical-electronic converters, averaging and differential calculators, analog-digital converters, etc. Also the number and selection of input channels may be different from application to application and without limiting the validity of this invention. For example in a three-phase machine the representation of the stator current, Ia, may be three individual values, an average of three values or the maximum value. Similarly, groups of temperatures can be averaged or the extreme values chosen as input value.

The secondary input port 4 in the central unit 2 is connected to an electronic data input device 16, for example a keyboard, where in addition to the commands and correction factors also fictive values for the earlier mentioned conditions, MW, MVAr, kV, etc., may be introduced for the purpose of performing analysis on “what if” operational scenarios. The introduction of fictive values can be an important tool to help the decision making prior to choosing the operational parameters to be introduced through the controller 11 into the electromagnetic apparatus.

The central unit 2 has a processor 5 which is essentially a electronic computer having connection to a clock 6, for timing and time measuring purpose.

The processor 5 performs the calculation of aging parameters and risk levels based on the operational condition information received on the primary 3 and secondary 4 input ports. In order to perform these computations a set of instructions also called program is required. The program contains the functions required to perform the computations converting the condition data from the input ports 3 and 4 into aging values.

The program can be extensive, therefore, the development of the program should be done on another computer and the finished program loaded into the memory of the central unit 2. Typically, there are two essential pre-requisites to create the program, a comprehensive and detailed knowledge of the electromagnetic apparatus 1. and a precise understanding the physical, chemical and mechanical processes causing the aging. These pre-requisites demand and detailed inspection and condition assessment of the given electromagnetic apparatus 1 and experience from a great number of comparable electromagnetic apparatus with sufficient long operational records.

The processor 5 under control of the program performs the operations as follows: Total life expectancy, Lte, is the duration of life of a given component in the electromagnetic apparatus assuming rated operational load conditions. This total life expectancy, for example Lte=40 years, can be regarded as Lte%=100%. Consequently, at rated conditions the rated aging speed would be var=1.0 year/year and the questionable component of the electromagnetic apparatus would last 40 years. The percentual rated aging velocity would be var%=100/40. equal to 2.5%. After 10 years at rated conditions the component would have used up Lu=10 years of life and the remaining life would be Lr=Lte−Lu equal 40−10=30 years. If the operational conditions due to higher than rated load, or other adverse non-rated parameters would increase the deterioration in the machines, the aging speed may increase for example to vai=1.21. Consequently, the used up life after ten years would be Lui=10×1.21, equal to 12.1 years. And the remaining life would be reduced to Lri =Lte−Lui, equal to 27.9 years. Applying a certain amount of money, Vr, to represent the value of 40 years of production at rated operation level, the modified operational conditions during a time period, tc years, could be expressed as a financial loss equivalent to

Vloss=Vr×tc×(Lr−Lri)/Lte

The program can be introduced into the central unit 2 either through the secondary input device 16 or more conveniently through a magnetic disk or optical disk or card reader 15. From there, the program can be transferred into the Random Access Memory 10 connected to the processor 5 and eventually re-directed into the large storage unit 7 which can be a so-called hard drive.

The calculated values from the processor 5 are transferred to output port 17 which may have three communication directions. Connected to a readout device 8, for example a TV-monitor or liquid crystal screen, the calculated present aging values, such as aging speed, used and remaining life, risk factor for each essential component can be shown in one section of the screen, while the other section of the screen can be used to present the results of the experimenting with fictive load conditions in connection with the “what if” analysis.

Another communication line 18 from the output port can be channeled through wired or wireless communication lines to a remote location, for example to a load central. A third option is a communication line 19 leading to the control unit 11 which controls both the electromagnetic apparatus 1 and the non-electromagnetic apparatus 20 via the control lines 9. The purpose of this communication line 19 can be to provide an overload protection preventing introduction of load combinations with extreme risk level or aging speed. The adjustment of these limits can be done either at the secondary input device 16 or in the control unit 11.

In accordance with this invention, one central unit can serve more than one electromagnetic apparatus having independent connection from their instrumentation 12 to the primary input port 3. Serving more than one electromagnetic apparatus may require that each apparatus 1 will be calculated by independent programs stored in the same or different storage devices 7 and 10. Even if the individual electromagnetic apparatus are similar, there will always be some differences for example due to the age differences, repair and modification works, etc. For example the winding may have been replaced.

In accordance with this invention, different types of electromagnetic devices can be served by the same central unit 2. For example, generators and transformers may be connected to the same central unit 2. However, each of these electromagnetic apparatus must have their own program.

Furthermore, the same central unit 2 can receive condition signals from a non-electromagnetic apparatus 20 for example from a turbine. In this case the signals received from the instruments and probes 21 will go through signal conditioning and conversion 22 followed by amplification, filtering and analogue-digital conversion 23 and reach the central unit's 2 primary input port 3. The received condition signals may be used as complementary information to those received from the electromagnetic apparatus or as a base for aging calculation of the non-electromagnetic apparatus using special programs.

The type of interconnections between components of the aging measuring device, for example electric conductors, cables, fiber-optics, wire-less devices, etc. are not limiting the validity of this invention. Most of the components, processors, storage, input and output components, etc., involved in the aging measuring device are commercially available and their internal connections, structure, material choice and other features are not regarded limiting to the validity of the invention.

What is claimed is:

1. Age measuring device comprising of instruments measuring the current electric, magnetic, thermal, mechanical, radiation, climatic and chemical conditions in the electromagnetic apparatus and via signal cables, signal conditioning and conversion components connected to the primary input port of a central unit transferring the converted electrical signals to the processor and a secondary input port transferring operation commands, constants and fictive operational conditions from manually operated input device to the processor which operation is controlled by programs specific for the electromagnetic apparatus and stored temporarily in the Random Access Memory and accessible for the connected large capacity memory drive and an output port connected to the processor communicating the calculated aging speed, used up life, remaining life and risk level to the connected readout device showing the calculated aging speed, used up life, remaining life and risk level.

2. Age measuring device in accordance with claim 1 including:
connection between more than one electromagnetic apparatus having more than one set of instruments measuring the current electric, magnetic, thermal, mechanical, radiation, climatic and chemical conditions in the electromagnetic apparatus and via signal cables, signal conditioning and conversion components connecting them to the primary input port.

3. Age measuring device in accordance with the foregoing claims including:
connection between non-electromagnetic apparatus having instruments measuring the current electric, magnetic, thermal, mechanical, radiation, climatic, chemical and hydrodynamic conditions in the non-electromagnetic apparatus and via signal cables, signal conditioning and conversion components connecting them to the primary input port.

4. Age measuring device in accordance with claim 3, including:
programs stored in the central unit for calculation of aging of non-electromagnetic apparatus.

5. Age measuring device in accordance with the foregoing claims including:
communication lines between the output port and a remote readout device.

6. Age measuring device in accordance with the foregoing claims including:
communication lines between the output port and the control unit of the electromagnetic and non-electromagnetic apparatus.
